(19) United States
(12) Patent Application Publication
(10) Pub. No.: US 2011/0065611 A1
(43) Pub. Date: Mar. 17, 2011

(54) Apparatus for treatment of light-sensitive biopolymers

(76) Inventors: Cornelis Jacobus Maria Heemskerk, Sassenheim (NL); Stefan Matthias Matysiak, Somerville, MA (US); Johannes Martinus Lambertus Maria Van Helvoort, Zeist (NL)

(21) Appl. No.: 12/803,860

(22) Filed: Jul. 8, 2010

Related U.S. Application Data
(63) Continuation-in-part of application No. 10/925,528, filed on Aug. 25, 2004, now abandoned.

(51) Int. Cl. C40B 50/14; C40B 60/14

(52) U.S. Cl. 506/30; 506/40

(57) ABSTRACT

A method of fabricating a device comprising an array of test locations defined on a substrate with each test location comprising one or more identical oligonucleotides affixed to the substrate. The method comprises the steps of:
(1) identifying a nucleotide type to be attached at a particular test location in order to construct the one or more identical oligonucleotides at that test location and determining one or both of an illumination intensity and an illumination duration for a laser light source;
(2) directing a laser beam generated by the laser light source and having the determined intensity and/or duration at a mirror, the position of the mirror having been set so as to redirect the laser beam towards said test location, such that removal of a protective group or groups at the test location is achieved;
(3) attaching a nucleotide or nucleotides of said nucleotide type at the test location; and
(4) repeating said steps (1) to (3) at a plurality of test locations across the array in order to construct the required oligonucleotide(s) at each test location.

### CROSS-REFERENCE TO RELATED APPLICATION

This is a Continuation-in-Part of U.S. application Ser. No. 10/925,528, filed Aug. 25, 2004, the content of which is hereby incorporated by reference in its entirety.

### TECHNICAL FIELD

The invention relates to an apparatus for treating light-sensitive biopolymers, comprising at least a light source, a process chamber suitable for receiving a substrate on which the biopolymers are placed for treatment with light from the light source, and an allocation member for directing the light from the light source to the selected sites on the substrate.

### BACKGROUND

An apparatus of the type described above is known from the article “Mask-less fabrication of light-directed oligonucleotide microarrays using a digital micromirror array” by the authors Singh-Gason S. et al, published in 1999 in Nature Biotechnology vol. 17, pp 947-978. In the known apparatus an ultraviolet light source is followed by a filter and subsequently a reflection mask in the form of a digital micromirror array. Via this reflection mask the ultraviolet light is directed via a special projection screen onto the substrate in the process chamber for the formation of a DNA test array. The process chamber is connected with a so-called oligosynthesiser which serves for conducting the respective liquids necessary for the formation of the DNA test array to the process chamber or away from the process chamber.

Due to the light from the ultraviolet light source being projected selectively onto specific sites on the substrate, a local activation takes place of the respective photolabile group supplied with said liquids. In this manner a desired DNA nucleotide can be formed successively on any selected site on the substrate.

With such an apparatus it is possible to fabricate DNA test arrays of at least 40,000 nucleotide positions, which means that the formation of such an array is a time consuming process which moreover has to meet a high standard of accuracy in order to avoid incorrect nucleotide formation in positions adjacent to the illuminated sites. Consequently, high standards have to be met, for example, with respect to the accuracy and speed with which the allocation member can direct the light from the ultraviolet light source.

### SUMMARY

It is an object of the invention to meet these and other requirements that in practise have to be fulfilled by an apparatus of the kind mentioned in the preamble, and to provide such an apparatus that can be manufactured at relatively low cost and can, in addition, be easily transported.

A further object of the invention is to provide such an apparatus that can be used not only for the formation of a DNA test array but also for generally treating light-sensitive biopolymers.

Such biopolymers also include for example RNA and amino acids (peptides, proteins) that may or may not be modified, thus pure DNA, RNA and protein building blocks (nucleotides, amino acids), as well as those with particular modifications (fluorochromes, sugargroup-glycoproteins, phosphate, methyl), and also those of which the building blocks themselves are already modified (DNA, LNA, synthetic amino acids). The person skilled in the art will find no difficulty in further supplementing this list.

According to a first aspect of the present invention there is provided a method of fabricating a device comprising an array of test locations defined on a substrate with each test location comprising one or more identical oligonucleotides affixed to the substrate. The method comprises the steps of:
(1) identifying a nucleotide type to be attached at a particular test location in order to construct the one or more identical oligonucleotides at that test location and determining one or both of an illumination intensity and an illumination duration for a laser light source;
(2) directing a laser beam generated by the laser light source and having the determined intensity and/or duration at a mirror, the position of the mirror having been set so as to redirect the laser beam towards said test location, such that removal of a protective group or groups at the test location is achieved;
(3) attaching a nucleotide or nucleotides of said nucleotide type at the test location; and (4) repeating said steps (1) to (3) at a plurality of test locations across the array in order to construct the required oligonucleotide(s) at each test location.

Embodiments of the invention allow one or both of the laser illumination intensity and duration to be set on a per test location and/or per layer basis, i.e. varying from location to location and from layer to layer.

The step of determining one or both of an illumination intensity and an illumination duration for that nucleotide type may take into account the nucleotide type to be attached, a relative location of the test location on the substrate, and/or an identity of a nucleotide previously attached at said test location.

The method may comprise a further step of selecting one of two or more available lasers for generating said laser beam, the lasers being configured to generate laser beams having different wavelengths. The orientation of said mirror may be adjusted in order to step the laser beam across the substrate, the movement of the mirror being synchronised with steps (1) and (2).

The protective group(s) may be a photolabile group or groups. Alternatively, the protective group(s) may be a group(s) that is activated by light, e.g. an acid-labile group

According to a second aspect of the present invention there is provided apparatus for fabricating a device comprising an array of test locations defined on a substrate with each test location comprising one or more identical oligonucleotides affixed to the substrate. The apparatus comprises a laser light source for generating a laser beam and an illumination controller for determining one or both of an illumination intensity and an illumination duration for a given test location, and for controlling the laser light source accordingly to generate a laser beam. The apparatus further comprises a mirror, and a scan controller for setting the position of the mirror so as to redirect the laser beam towards said test location.

The illumination controller may be further configured to identify a nucleotide type to be attached at said given test location in order to construct the one or more identical oligonucleotides at that test location, and to determine one or both of said illumination intensity and said illumination duration taking into account the identity of the nucleotide type.

The apparatus may comprise at least two laser light sources configured to operate at respective different wavelength, said illumination controller being configured to select one of the available laser light sources to illuminate a given test location.

According to a third aspect of the present invention there is provided method of fabricating a device comprising an array of test locations defined on a substrate with each test location comprising two or more different oligonucleotide types affixed to the substrate. The method comprises, for a given test location:
(1) identifying an oligonucleotide type for which a nucleotide addition is to be made;
(2) selecting a laser light source from a set of two or more available laser light sources in dependence upon the identified oligonucleotide type;
(3) activating the selected laser light source and directing a laser beam at a mirror, the position of the mirror having been set so as to redirect the laser beam towards said test location, such that removal of a protective group or groups at the test location is achieved;
(4) attaching a nucleotide or nucleotides at the test location; and
(5) repeating steps (1) to (4) in respect of a further oligonucleotide type, step (2)
comprising selecting a second of the available laser light sources; repeating said steps (1) to (5) at a plurality of test locations across the array in order to construct the required different oligonucleotide(s) types at each test location.

The method may comprise, for each test location and for each identified oligonucleotide type, identifying one or both of an illumination intensity and an illumination duration, and activating the selected laser light source accordingly.

According to a fourth aspect of the present invention there is provided apparatus for fabricating a device comprising an array of test locations defined on a substrate with each test location comprising two or more different oligonucleotide types affixed to the substrate. The apparatus comprises two or more laser light sources for generating a laser beam, and an illumination controller for identifying an oligonucleotide type for which a nucleotide addition is to be made at a given test location, for selecting a laser light source from said two or more available lasers in dependence upon the identified oligonucleotide type, and for controlling the laser light source accordingly to generate a laser beam. The apparatus further comprises a mirror, and a scan controller for setting the position of the mirror so as to redirect the laser beam towards said test location.

The apparatus may comprise a process chamber for receiving a substrate on which said oligonucleotides are to be formed, and one or more conduits for introducing nucleotides into the process chamber.

In a first aspect, the apparatus is characterised in that the allocation member comprises at least one motor-driven mirror, the mirror is mounted on a rotatable spool arranged between poles of a device generating a magnetic field, and that the allocation member has an adjustable source of electricity connected with the spool for controlling the orientation of the mirror. This has been shown to provide a fast and accurately working allocation member of relatively little complexity, that in addition can be realised at low costs, and that can be widely used in the above mentioned field. For example, the apparatus according to the invention makes it possible to simply carry out a flow synthesis in a number of consecutive synthesis steps, with the area to be illuminated being moved on slightly for each subsequent synthesis step.

In this way a wide variety of built up molecules can be realised, which may vary especially in length.

It is remarked that the substrate may be immobilised or attached to a solid support in the form of, among other things but not exclusively, a smooth surface such as a microscope slide, a porous matrix, smooth or porous spheres, or gel coating.

The apparatus according to the invention may be suitably realised by using a so-called galvanomirror for the allocation member.

For an economical energy consumption the mirror is preferably dielectrically coated to realise a reflection coefficient of at least 0.99 in the relevant wave range of the light to be reflected.

It is further preferred for the motor of the mirror to be temperature-stabilised. This measure guarantees a high reproducibility of the adjustment behaviour of the allocation member.

In a further aspect of the invention, the apparatus is characterised in that a focusing lens, preferably an F-theta lens is placed in the optical path between the mirror and the substrate. This further increases the precision of positioning the light beam on the substrate. As this substrate is generally flat, a correction is necessary for the light reflected by the mirror, whose focusing point will only lie on the mirror axis in the plane of the substrate. A suitable F-theta lens useful for this purpose is such a lens from Sill Optics in Germany type number S4 LFT 3100.

As a rule it is also necessary to use a beam expander. This is known to the person skilled in the art and is used to produce a light spot of the correct dimensions with the aid of the focussing lens.

In one suitable embodiment of the apparatus, the light source is embodied as ultraviolet light source. Good results can be attained if the ultraviolet light source operates in the 390 nm range, preferably at approximately 350 nm.

This is realised preferably by using a frequency-trebled Nd: YAG laser. Such a diode laser provides a low cost, low energy-consuming light source meeting the requirements that an apparatus for the treatment of light-sensitive biopolymers has to comply with.

### BRIEF DESCRIPTION OF THE DRAWINGS

FIG. 1 illustrates schematically an apparatus for use in fabricating an oligonucleotide microarray; and

FIG. 2 illustrates schematically an ideal laser beam spot intensity distribution and a distribution achieved in practice;

FIG. 3 illustrates schematically a series of oligonucleotides being constructed on a microarray, showing exemplary illumination times; and

FIG. 4 is a flow diagram illustrating a method of fabricating an oligonucleotide microarray.

### DETAILED DESCRIPTION

FIG. 1 shows an apparatus for preparing an oligonucleotide microarray, and in particular a DNA microarray. Such a microarray typically comprises an array of test locations, with each location comprising a multiplicity of identical oligonucleotids (in this example the oligonucleotids are DNA oligonucleotides). Within a given test location of course, a proportion of the oligonucleotides may be incorrectly formed such that less than 100% of oligonucleotides have the correct structure. Different test locations may be provided with the same or different oligonucleotides, e.g. in order to test for different DNA oligonucleotides.

The illustrated apparatus comprises an ultraviolet laser light source 1, and a process chamber 3 adapted to receive a substrate 6 on which the DNA microarray is formed. This substrate may be, for example, glass, polypropylene or another suitable material.

For the preparation of the DNA microarray there is further provided an allocation member 2. The allocation member directs light from the laser light source 1 for illuminating selected sites on the substrate 6 in the process chamber 3. Conduits 4 are provided for the supply and discharge of liquids to the test locations.

The allocation member 2 may be embodied as a motor-driven mirror or mirrors, each of which is mounted on rotatable spools disposed in a magnetic field, for example, by arranging the spools between the poles of a permanent magnet. The Figure further shows a computer-controlled regulator 5, which serves for adjusting the current to be conducted through the spool or spools, so that the mirror placed thereon assumes the desired position corresponding with the site to be illuminated on the substrate 6. It is advantageous to use as said allocation member 2 a so-called “galvanomirror”. Such a galvanomirror has been known for many years, is extremely accurate, and is available at relatively low cost.

It is further advantageous and generally also desirable for the motor of the mirror to be temperature-stabilised, for example at approximately 50 C, in order to achieve a high degree of reproducibility of the adjustment behaviour of the mirror.

The allocation member 2 preferably comprises a focusing lens, and more preferably a so-called F-theta lens, placed in the optical path between the mirror and the substrate 6. The manner in which this is executed is completely known to the person skilled in the art so that no further explanation is required.

For the ultraviolet laser light source it is desirable to use a source that operates in the 340-390 nm range, preferably at approximately 350 nm. A suitable laser light source is a Nd: YAG laser with a trebled frequency.

FIG. 1 also illustrates an illumination controller 7 which is arranged to control various aspects of the illumination provided by the laser light source 1. Also provided is a memory 8 which can be accessed by the illumination controller. The illumination controller 7 (and memory 8) may be implemented with a computer that also implements the computer-controlled regulator 5, such that illumination properties and direction are controlled in synchronisation.

For each layer of nucleotides to be added to the oligonucleotides being constructed, selective illumination has to be repeated four times to cover the four possible nucleotides (A, C, G or T). Thus, for an array with 60-mer long oligonucleotide strands, up to 240 illumination cycles are needed to completely construct the microarray. The laser spot size is measured in microns (10⁻⁶ m), typically in the order of 10 to 40 microns, while the molecules are measured in nanometres (10⁻⁹ m). This means that one test location will contain many molecules. The rate of “deprotection” resulting from an illumination depends on the number of photons that hit the photodeprotective groups per unit of time, i.e. on the intensity of the light. The light intensity of the laser is determined by its power. The overall deprotection efficiency depends critically on how many photons are needed to remove all photodeprotective groups and is determined by the total illumination time at a certain light intensity (power).

Under moderate illumination conditions, deprotection can be considered a stochastic process: a certain illumination level and exposure time will result in a certain percentage of the molecules in the test location being deprotected. Molecules that are not correctly deprotected when the test location is illuminated may become deprotected in a subsequent illumination cycle. This will may result in an incorrect DNA sequence being formed (i.e. a write error). The sequential nature of the process makes it very important to achieve a very high percentage of deprotection within an illuminated test location. For example, even if 95% of the molecules within a given test location are correctly deprotected for a given illumination, after 60 cycles only 4% (0.95⁶⁰) of the oligonucleotides within that test location will be correct.

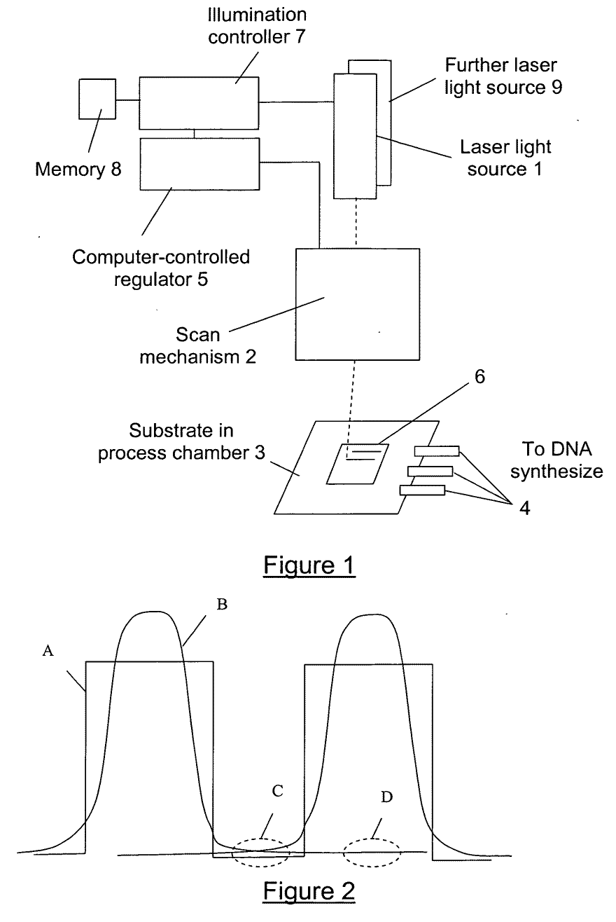

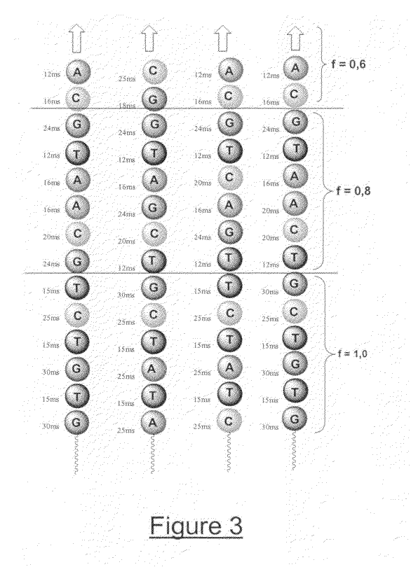

The ideal spot illumination pattern is a “top-hat” shape (FIG. 2, A). The top-hat shape implies that selective illumination is exclusively applied to the molecules in the illuminated test location. Sufficiently long exposure of the location at sufficient light intensity will ensure that nearly all molecules in the test location are activated and ready for binding. The ideal top-hat shaped illumination pattern evenly illuminates the area inside the test location and does not illuminate any molecules outside of that location.

A spot projected by a real laser bundle is not a top-hat shape however. It typically approximates more the shape of a Gaussian curve (FIG. 2, B). The image projected by the trailing edges of a laser bundle consecutively illuminating two adjacent test locations will show some overlap (as indicated by C in FIG. 2), yielding an unwanted background signal. The closer two location areas are together on the array surface, the more disturbance ‘crosstalk’ the illumination of one test location will give rise in the neighbouring test location (as indicated by D in FIG. 2). The higher the intensity and the longer the exposure time, the higher the undesired background signal the area will be.

Experiments have also shown that there is a significant variation of the individual 5′-protected nucleobase in deprotection rate and efficiency depending on their chemical composition and length. FIG. 2 illustrates individual laser deprotection times depending on nucleobase and relative position along growing chains of monomers (f=correction factor).

A further cause of error in the sequencing operation may be due to inaccuracies in optical alignment, limitations in the quality of the optical components, and changes in the optical alignment due to changing environmental conditions during the process. These factors may in turn influence the light intensity inside the spot, such that signal intensity will vary across the surface of a microarray.

The problems considered above may be addressed by controlling and adjusting the intensity of the laser light as well as the exposure time under external control, depending upon one or more of the chemical composition of the photolabile protecting group, the particular biomolecular building block attached in a previous cycle, the nucleotide currently being attached, and the location of the test location (other factors may also be taken into account). Individual adjustment per test location is achieved in the apparatus of FIG. 1 by the illumination controller 7. By adjusting the illumination power and the illumination time for each individual test location, optimal deprotection can be achieved. The combination of a laser light source and sequential addressing of the test locations with a set of steerable mirrors uniquely allows control of both the illumination power (intensity) and the illumination time individually for each test location. For optimal results, test location size and the inter-test location distances are controlled, as well as exposure time and light intensity. It has been observed that the light intensity (power) determines the size and shape of the feature and this can be used for optimization.

A microarray is typically provided with one or more “quality control” features. These are provided at specific locations within the array and are designed to generate a test signal when the device is read. Experimental results have shown that the (read) signal intensity distribution across such quality control features is determined primarily by the exposure times used to construct the features. For example, overexposure may result in “holes” appearing in the distribution across a test location. This means that it is important to be able to vary exposure time for all test locations, per test location and per layer.

It is further noted that the response of light sensitive polymers to illumination is a multi-step process. After a photon is absorbed, the molecule that is excited will enter an intermediate state (‘triplet state’). This reaction is very fast. Then, in a much slower process, the intermediate state is replaced by the activated state. The intermediate state is sensitive to damage. If a molecule in the intermediate state is hit again by a photon, the molecule is damaged. The amount of damage depends on the number of cycles applied. Different test locations can have different lengths of oligonucleotides, hence the amount of damage can vary. Results have shown that administering the same amount of energy over an extended exposure time at lower intensity will yield better results. This can be achieved using the apparatus of FIG. 1, e.g. adjusting laser power and exposure depending upon the total length of the oligonucleotide constructed (number of exposure cycles or the type of application).

For certain assays in molecular biology (e.g. “Bridge” PCR) it is beneficial to combine two different sequences either in the same (2×3′ to 5′) or opposite (1×3′ to 5′/1×5′ to 3′) directions in the same test location. The simplest way to achieve this is to use a surface with an acid labile protected anchor group and a photolabile protected function. Acid labile groups with a chromophoric system, such as the commonly used Dimethoxytrytil (DMT), can at least partially and with a photosensitizer be removed with a light source such as a mercury lamp. Applying optical filters seems not to fully eliminate the partial removal of DMT however, which leads to unwanted side reactions and therefore false or truncated sequences.

Using a laser allows the application of orthogonal photodeprotection. For the synthesis of two different probes in the same test location, different photodeprotecting groups have to be used. The oligonucleotides forming the probes are classified according to the nature of the protecting groups used, i.e. one oligonucleotide type is protected by a protecting group of a first type whilst a second oligonucleotide type is protected by a protecting group of a second type. The photodeprotecting groups must have non-overlapping absorption spectra for deprotection. This can be best achieved using two lasers, one for each protecting group. An additional laser 9 is easily incorporated in to the apparatus of FIG. 1. In contrast to the continuous wavelength spectrum of a mercury lamp, a laser with its defined monochromic light allows specific deprotection in the presence of DMT, which enables the synthesis of at least two different sequences within a single test location.

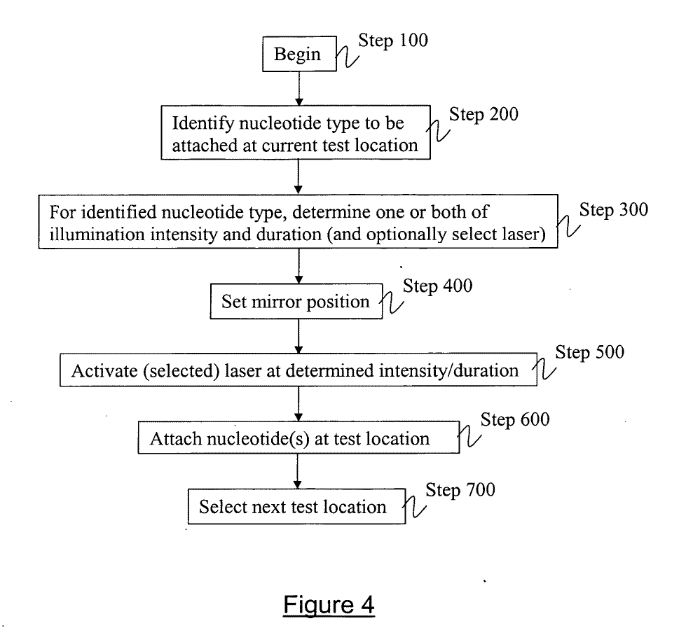

FIG. 4 is a flow diagram illustrating a method of fabricating a microarray of the type described above. The process commences at step 100, followed by a step 200 of identifying a nucleotide type to be attached at a particular test location in order to construct one or more identical oligonucleotides at that test location. One or both of an illumination intensity and an illumination duration for that nucleotide type are then determined, step 300. The mirror is then positioned appropriately, step 400. A laser beam having the determined intensity and/or duration is directed at a mirror, step 500. Illumination of the test location achieves removal of a photolabile group or groups at the test location. A nucleotide or nucleotides of the selected nucleotide type are attached to the growing molecule at the test location, step 600. A new test location is then selected, step 700, and the process repeated in order to construct the required oligonucleotide(s) at each test location.

It will be appreciated by the person of skill in the art that various modifications may be made to the above described embodiments without departing from the scope of the present invention.

1. A method of fabricating a device comprising an array of test locations defined on a substrate with each test location comprising one or more identical oligonucleotides affixed to the substrate, the method comprising:
(1) identifying a nucleotide type to be attached at a particular test location in order to construct the one or more identical oligonucleotides at that test location and determining one or both of an illumination intensity and an illumination duration for a laser light source;
(2) directing a laser beam generated by the laser light source and having the determined intensity and/or duration at a mirror, the position of the mirror having been set so as to redirect the laser beam towards said test location, such that removal of a protective group or groups at the test location is achieved;
(3) attaching a nucleotide or nucleotides of said nucleotide type at the test location; and
(4) repeating said steps (1) to (3) at a plurality of test locations across the array in order to construct the required oligonucleotide(s) at each test location.

2. A method according to claim 1, wherein said step of determining one or both of an illumination intensity and an illumination duration for that nucleotide type takes into account the nucleotide type to be attached.

3. A method according to claim 1, wherein said step of determining one or both of an illumination intensity and an illumination duration for that nucleotide type takes into account a relative location of the test location on the substrate.

4. A method according to claim 1, wherein said step of determining one or both of an illumination intensity and an illumination duration for that nucleotide type takes into account an identity of a nucleotide previously attached at said test location.

5. A method according to claim 1 and comprising a further step of selecting one of two or more available lasers for generating said laser beam, the lasers being configured to generate laser beams having different wavelengths.

6. A method according to claim 1, wherein the orientation of said mirror is adjusted in order to step the laser beam across the substrate, the movement of the mirror being synchronised with steps (1) and (2).

7. A method according to claim 1, wherein said protective group(s) is(are) a photolabile group or groups.

8. Apparatus for fabricating a device comprising an array of test locations defined on a substrate with each test location comprising one or more identical oligonucleotides affixed to the substrate, the apparatus comprising:
a laser light source for generating a laser beam;
an illumination controller for determining one or both of an illumination intensity and an illumination duration for a given test location, and for controlling the laser light source accordingly to generate a laser beam;
a mirror; and
a scan controller for setting the position of the mirror so as to redirect the laser beam towards said test location.

9. Apparatus according to claim 8, said illumination controller being further configured to identify a nucleotide type to be attached at said given test location in order to construct the one or more identical oligonucleotides at that test location, and to determine one or both of said illumination intensity and said illumination duration taking into account the identity of the nucleotide type.

10. Apparatus according to claim 8 and comprising at least two laser light sources configured to operate at respective different wavelengths, said illumination controller being configured to select one of the available laser light sources to illuminate a given test location.

11. A method of fabricating a device comprising an array of test locations defined on a substrate with each test location comprising two or more different oligonucleotide types affixed to the substrate, the method comprising, for a given test location:
(1) identifying an oligonucleotide type for which a nucleotide addition is to be made;
(2) selecting a laser light source from a set of two or more available laser light sources in dependence upon the identified oligonucleotide type;
(3) activating the selected laser light source and directing a laser beam at a mirror, the position of the mirror having been set so as to redirect the laser beam towards said test location, such that removal of a protective group or groups at the test location is achieved;
(4) attaching a nucleotide or nucleotides at the test location; and
(5) repeating steps (1) to (4) in respect of a further oligonucleotide type, step (2) comprising selecting a second of the available laser light sources;
repeating said steps (1) to (5) at a plurality of test locations across the array in order to construct the required different oligonucleotide(s) types at each test location.

12. A method according to claim 11 and comprising, for each test location and for each identified oligonucleotide type, identifying one or both of an illumination intensity and an illumination duration, and activating the selected laser light source accordingly.

13. Apparatus for fabricating a device comprising an array of test locations defined on a substrate with each test location comprising two or more different oligonucleotide types affixed to the substrate, the apparatus comprising:
two or more laser light sources for generating a laser beam;
an illumination controller for identifying an oligonucleotide type for which a nucleotide addition is to be made at a given test location, for selecting a laser light source from said two or more available lasers in dependence upon the identified oligonucleotide type, and for controlling the laser light source accordingly to generate a laser beam;
a mirror; and
a scan controller for setting the position of the mirror so as to redirect the laser beam towards said test location.

14. Apparatus according to claim 13 and comprising a process chamber for receiving a substrate on which said oligonucleotides are to be formed, and one or more conduits for introducing nucleotides into the process chamber.
